(19) United States
(12) Patent Application Publication
(10) Pub. No.: US 2023/0306236 A1
(43) Pub. Date: Sep. 28, 2023

(54) DEVICE AND METHOD FOR EXECUTING LSTM NEURAL NETWORK OPERATION

(71) Applicant: ESPRESSIF SYSTEMS (SHANGHAI) CO., LTD., Shanghai (CN)

(72) Inventor: Xiangyu SUN, Shanghai (CN)

(21) Appl. No.: 18/019,672

(22) PCT Filed: Jul. 16, 2021
(86) PCT No.: PCT/CN2021/106853

§ 371 Date: Feb. 3, 2023

(30) Foreign Application Priority Data
Aug. 3, 2020 (CN) 202010775213.7

(51) Int. Cl. G06N 3/063

(52) U.S. Cl. CPC G06N 3/0442; G06N 3/063

(57) ABSTRACT

Provided are a device and a method for executing LSTM neural network operation. The device includes a processor, a first operation module, a second operation module, as well as a processor cache, a main memory and a secondary memory with access speeds ranked in a descending order. The first operation module reads input vectors of K frames from a current layer and one row from a first submatrix of a parameter matrix into the processor cache, and the processor performs a multiply-accumulate operation between the input vectors of the K frames and one row after another of the first submatrix, to obtain a first intermediate result vector corresponding to each of the K frames. The second operation module computes a second intermediate result vector corresponding to each of the K frames, and computes an output vector of a current frame.

### CROSS-REFERENCE TO RELATED APPLICATIONS

This application is the U.S. National Phase Application under 35 U.S.C. § 371 of International Patent Application No. PCT/CN2021/106853 filed on Jul. 16, 2021, which claims priority to Chinese Patent Application CN202010775213.7 filed on Aug. 3, 2020. The disclosures of the aforementioned applications are hereby incorporated by reference in their entireties.

### TECHNICAL FIELD

The present disclosure relates to the field of artificial neural network is technology, in particular to a device and a method for executing LSTM neural network operation.

### BACKGROUND

With the continuous development of speech interaction and Internet of Things, a broad range of embedded devices are configured with simple artificial intelligence (AI) functions such as offline speech recognition and voiceprint recognition. To meet requirements of low cost and low power consumption, the embedded device is provided with relatively small memory and limited operation resources in general. Therefore, the implementation and deployment of AI technologies (e.g., artificial neural networks) on embedded devices are greatly limited.

Long Short Term Memory (LSTM) is a neural network architecture used in the field of deep learning, which is widely used in sequence-based machine learning applications such as speech recognition, voiceprint recognition and optical character recognition. However, running the LSTM model in an embedded system is a particularly huge challenge, mainly for two reasons set out below.

On one hand, for speech recognition and similar tasks, recognition performance is positively correlated with a quantity of LSTM parameters, i.e., the recognition performance is improved with the quantity of LSTM parameters. However, the available maximum quantity of LSTM parameters is limited by a memory of the embedded system. That is, the possibility of improving model performance by increasing the quantity of the LSTM parameters is limited, thus resulting in unsatisfactory recognition effects of the embedded device and poor user experience.

On the other hand, LSTM is an iteration-like operation mode. Concretely, operation at each step depends on output of the previous step, as shown in FIG. 1. FIG. 1 is a simplified schematic block diagram of an existing LSTM neural network operation, which shows a plurality of units (from 102, 104 through to 106) of the is LSTM neural network, I(i), I(i+1) through to I(i+n) represent the outputs of a i^{th} frame to a (i+n)^{th} frame of a previous layer of the LSTM neural network respectively, and O(i), O(i+1) through to O(i+n) represent the outputs of the i^{th} frame to the (i+n)^{th} frame of a current layer respectively. It can be seen that the operation of every unit depends on the output of the previous unit. A LSTM computational bottleneck mainly lies in internal matrix operation. The matrix operation can be divided into two parts, i.e., parameter reading and multiply-accumulate (MAC) operation. In the existing embedded chips, more than one MAC operation unit, even more than one hundred operation units are configured to parallelize the MAC operations. However, due to the iterative operation mode, LSTM operation of every frame depends on the result of the previous frame, thus each LSTM operation could be carried out only after reading parameters from RANI or flash. In the embedded device, the cache, RANI and flash (ROM) are ranked in a descending order of access speed. However, the quantity of LSTM parameters (at least several hundreds KB) is usually larger than the cache of the embedded device, thus resulting in failure of multiplexing cached data. Therefore, the parameter reading takes a large amount of time and the LSTM neural network operation works at low efficiency in the existing embedded system.

Specifically, the LSTM neural network operation may be expressed as the following formula:

$$LSTM : {h}_{t}^{l - 1} , {h}_{t - 1}^{l} , {c}_{t - 1}^{l} \to {h}_{t}^{l} , {c}_{t}^{l}$$

$$\begin{matrix}( \begin{matrix}i \\ f \\ o \\ g\end{matrix} ) = ( \begin{matrix}s i g m o i d \\ s i g m o i d \\ s i g m o i d \\ t a n h\end{matrix} ) {T}_{4 n , m + n} ( \begin{matrix}{h}_{t}^{l - 1} \\ {h}_{t - 1}^{l}\end{matrix} ) \\ {c}_{t}^{l} = f ⊗ {c}_{t - 1}^{l} + i ⊗ g \\ {h}_{t}^{l} = o ⊗ tanh ( {c}_{t}^{l} )\end{matrix}$$

where:
T_{4n,m+n} is a 4n×(m+n) dimensional LSTM parameter matrix, h^{l-1} is a m×1 dimensional LSTM input vector, and h^{l} is a n×1 dimensional LSTM output vector;
l indicates the number of layers in the neural network;
t indicates the number of input frames;
hₜ^{l-1} is a m×1 dimensional vector, which is an output of a layer l−1 (i.e., the layer previous to a layer l) at frame t in the neural network model;
hₜ₋₁^{l} is a (IA dimensional vector, which is an output of the layer l (i.e., the current LSTM layer) at frame t−1 in the neural network model;
hₜ^{l} is a n×1 dimensional vector, which is an output of the layer l (i.e., the current LSTM layer) at frame t in the neural network model;
cₜ₋₁^{l} is a n×1 dimensional vector, which is a state of the layer l (i.e., the current LSTM layer) at frame t−1 of the neural network;
cₜ^{l} is a n×1 dimensional vector, which is a state of the layer l (i.e., the current LSTM layer) at frame t of the neural network;
i is a n×1 dimensional input gate vector;
f is a n×1 dimension forget gate vector;
is a n×1 dimensional output gate vector; and
g is a n×1 dimensional candidate memory cell vector.

Where, i, f, o and g are collectively called as gated vectors of LSTM, cₜ₋₁^{l} and cₜ^{l} are state vectors of the l layer of the LSTM neural network at frame t−1 and frame t, respectively.

A typical process of executing LSTM neural network operation in the existing embedded system is as follows:
1. copying all LSTM parameters from flash into random access memory (RAM);
2. accessing, by CPU, the LSTM parameter T_{4n,m+n} and input data hₜ^{l-1}, hₜ₋₁^{l} and cₜ₋₁^{l} stored in RAM via cache; and
3. computing LSTM: hₜ^{l-1}, hₜ₋₁^{l}, cₜ₋₁^{l}→hₜ^{l}, cₜ^{l}, where a major computation is matrix operation of

$${T}_{4 n , m + n} ( \begin{matrix}{h}_{t}^{l - 1} \\ {h}_{t - 1}^{l}\end{matrix} ) :$$

in the matrix operation, a multiplexing ratio of the cached data is zero due to the parameter T_{4n,m+n}, being larger than the cache size and frame-by-frame iterative computation of the LSTM.

The inventor noted that various solutions for accelerating the existing LSTM neural network operation mainly focus on improvement of computing capability and the reduction of I/O data transfer overhead, while ignoring optimization of the embedded device and cached data multiplexing.

For example, the Chinese patent application CN108268939A discloses an apparatus and a method for executing LSTM neural network operation. The apparatus and the method adopt a plurality of data cache units arranged in parallel, in which weights and biases sharded according to neurons for LSTM neural network operation are stored. These data cache units share the same quantity of weights and biases and each of the data cache units obtains a full set of input data. The frame-by-frame LSTM operation is performed and redundant input data is stored in the plurality of data cache units, without considering or solving the deficiency that the multiplexing ratio of the cached data is zero when the LSTM neural network operation is executed in the embedded system.

For another example, the Chinese patent application CN103068021A discloses a hardware accelerator for LSTM network, which performs a combinatorial operation on a first output and a second output corresponding to the same input and cached in a first cache via a combination module, thus obtaining a combinatorial output corresponding to the same input. Therefore, the bidirectional LSTM network operation is accelerated by improving the performance of bidirectional LSTM operation and shortening the response latency. Similarly, this patent application discloses an LSTM operation is performed in the frame-by-frame mode, and focuses on the optimization of bidirectional LSTM network operation for the multiplexing of the cache, but fails to consider or solve the deficiency that the multiplexing ratio of the cached data is zero when LSTM neural network operation is executed in the embedded system.

To sum up, it is desired to provide a device and a method for executing LSTM neural network operation, which can improve the multiplexing ratio of the cached data when executing the LSTM neural network operation in an embedded system, to solve the above-described deficiencies in the existing techniques. It should be appreciated that the listed technical deficiencies are for illustrating the present disclosure only and are not intended to limit the scope thereof. The present disclosure is not limited to the technical solution for solving all of the above-described technical deficiencies at the same time. The technical solutions of the present disclosure may be implemented to solve one or more of the above-described or other technical deficiencies.

### SUMMARY

To solve above-described deficiencies, an object of the present disclosure is to provide a device and a method for executing LSTM neural network operation, which can effectively improve a multiplexing ratio of cached data and computing efficiency for LSTM neural network operation in an embedded system featured by limited memory and computing capability.

According to an aspect, the present disclosure provides a device for executing LSTM neural network operation, including a processor, a processor cache, a main memory, a secondary memory, a first operation module and a second operation module, wherein an access speed of the processor cache is higher than that of the main memory, and an access speed of the main memory is higher than that of the secondary memory. The first operation module is operable to read input vectors of K frames from a current layer into the processor cache and read one row after another from a first submatrix of a LSTM parameter matrix into the processor cache, to enable the processor to perform an multiply-accumulate operation between the input vectors of the K frames and one row after another of the first submatrix, until traversing all rows of the first submatrix to obtain a first intermediate result vector corresponding to each of the K frames, wherein K is greater than 1 and K is selected such that sizes of the input vectors of the K frames and of one row of the first submatrix of the LSTM parameter matrix are smaller than a size of the processor cache. For each of the K frames, the second operation module is operable to: enable the processor to compute a second intermediate result vector corresponding to each frame according to a second submatrix of the LSTM parameter matrix, the first intermediate result vector and an LSTM output vector of a previous frame; and update an LSTM gated vector and an LSTM state vector, and compute an LSTM output vector of a current frame according to the first intermediate result vector and the second intermediate result vector.

In some embodiments, the second operation module is operable to read the first intermediate result vector of the current frame and the LSTM output vector of the previous frame into the processor cache, and to enable the processor to access the second submatrix stored in one of the main memory and the secondary memory, thereby the processor computes the second intermediate result vector for each frame according to the second submatrix of the LSTM parameter matrix, the first intermediate result vector and the LSTM output vector of the previous frame.

In some embodiments, the first submatrix of the LSTM parameter matrix of the current layer is stored in the main memory.

In some embodiments, the first submatrix of the LSTM parameter matrix of the current layer is stored in the secondary memory.

In some embodiments, the LSTM parameter matrix includes the first submatrix and the second submatrix.

According to another aspect, the present disclosure provides a method for executing LSTM neural network operation by using an electronic device. The electronic device includes a processor, a processor cache, a main memory and a secondary memory, wherein an access speed of the processor cache is higher than that of the main memory, and an access speed of the main memory is higher than that of the secondary memory. The method includes following steps: reading input vectors of K frames from a current layer into the processor cache and reading one row after another from a first submatrix of a LSTM parameter matrix into the processor cache, and performing an multiply-accumulate operation between the input vectors of the K frames and one row after another of the first submatrix, until traversing all rows of the first submatrix to obtain a first intermediate result vector corresponding to each of the K frames, wherein K is greater than 1 and K is selected such that sizes of the input vectors of the K frames and of one row of the first submatrix of the LSTM parameter matrix are smaller than a size of the processor cache. For each of the K frames, the method includes performing following steps: computing a second intermediate result vector corresponding to each frame according to a second submatrix of the LSTM parameter matrix, the first intermediate result vector and an LSTM output vector of a previous frame; and updating an LSTM gated vector and an LSTM state vector, and computing an LSTM output vector of a current frame according to the first intermediate result vector and the second intermediate result vector.

In some embodiments, the first intermediate result vector of the current frame and the LSTM output vector of the previous frame are read into the processor cache, and the processor is enabled to access the second submatrix stored in one of the main memory and the secondary memory, thereby the processor computes the second intermediate result vector for each frame according to the second submatrix of the LSTM parameter matrix, the first intermediate result vector and the LSTM output vector of the previous frame.

In some embodiments, one row of the first submatrix of the LSTM parameter matrix of the current layer is read from the main memory into the processor cache.

In some embodiments, one row of the first submatrix of the LSTM parameter matrix of the current layer is read from the secondary main memory into the processor cache.

With regard to the limited memory and computing capability of the embedded system, the present disclosure provides a novel LSTM operation device and method to effectively reduce the memory usage by LSTM model operation and improve the multiplexing ratio of the cached data and/or accelerate LSTM model operation, thereby improving the performance of LSTM model-based applications, in particular the efficiency of executing LSTM neural network operation in the embedded system.

It should be understood that the above-described background and summary of the present disclosure should be considered to be illustrative instead of limitation thereto.

### BRIEF DESCRIPTION OF DRAWINGS

FIG. 1 is a simplified schematic block diagram of LSTM neural network operation in the existing techniques.

FIG. 2 is a schematic block diagram of a device for executing LSTM neural network operation according to an embodiment of the present disclosure.

FIG. 3 is a schematic block diagram of a device for executing LSTM neural network operation according to another embodiment of the present disclosure.

FIG. 4 is a schematic flowchart of a computing process performed by a first operation module of the device for executing LSTM neural network operation according to an embodiment of the present disclosure.

FIG. 5 is a schematic flowchart of a computing process performed by a second operation module of the device for executing LSTM neural network operation according to an embodiment of the present disclosure.

FIG. 6 is a schematic flowchart of a method for executing LSTM neural network operation according to an embodiment of the present disclosure.

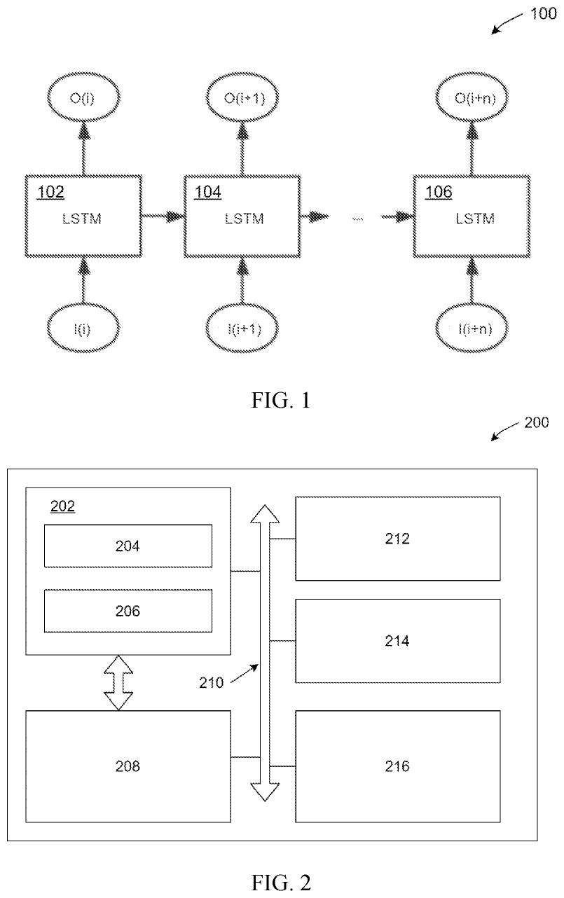

### DETAILED DESCRIPTION OF EMBODIMENTS

The present disclosure will be more completely described in combination with the accompanying drawings, which form a part of the present disclosure and give exemplary embodiments through illustration. It should be understood that the embodiments shown in the accompanying drawings and described below are merely illustrative of and not limiting on the present disclosure.

FIG. 2 is a schematic block diagram of a device 200 for executing LSTM neural network operation according to an embodiment of the present disclosure. Referring to FIG. 2, the device includes a processor 202, a main memory 208, a secondary memory 216, a first operation module 212, a second operation module 214 and a bus 210. The processor 202 further includes a processor core 204 and a processor cache 206. An access speed of the processor cache 206 is higher than that of the main memory 208, and an access speed of the main memory 208 is higher than that of the secondary memory 216. It should be understood that the processor cache 206 is shown as a part of the processor 202 in FIG. 2, the embodiment of the present disclosure is not limited thereto. For example, the processor cache 206 may be arranged outside the processor. As an example and not by way of limitation, the processor cache may be implemented as different levels of cache, the main memory may be implemented as a volatile memory such as Random Access Memory (RAM), DRAM, SDRAM, SDRAM and PSRAM, and the secondary memory may be implemented as a nonvolatile memory such as flash, Read Only Memory (ROM), PROM, EPROM, OTPROM and EEPROM. It should be understood that both of the main memory and the secondary memory may also be implemented as volatile memories.

The first operation module 212 is operable to read input vectors of K frames from a current layer of the LSTM neural network into the processor cache 206, and read one row after another from a first submatrix of a LSTM parameter matrix into the processor cache 206, and the processor 202 performs an multiply-accumulate operation between the input vectors of the K frames and one row after another of the first submatrix, until traversing all rows of the first submatrix, to obtain a first intermediate result vector corresponding to each of the K frames. As a non-limiting example, K is greater than 1 and K is selected such that sizes of the input vectors of the K frames and of one row of the first submatrix of the LSTM parameter matrix are smaller than a size of the processor cache 206. Thereby, each row of the first submatrix of the LSTM parameter matrix can be stored in the processor cache 206, and can be further multiplexed for computing with the input vectors of the K frames.

For each of the K frames, the second operation module 214 is operable to: enable the processor 202 to compute a second intermediate result vector corresponding to each frame according to a second submatrix of the LSTM parameter matrix, the first intermediate result vector and an LSTM output vector of a previous frame; and update an LSTM gated vector and an LSTM state vector, and compute an LSTM output vector of a current frame according to the first intermediate result vector and the second intermediate result vector.

Referring to FIG. 2, the processor 202, the main memory 208, the secondary memory 216, the first operation module 212 and the second operation to module 214 are coupled to the bus 210. However, it should be understood that the present disclosure is not limited thereto. The present disclosure may be implemented in a computing system or an embedded device with or without bus, and components may be connected in a way other than those illustrated.

The second operation module is operable to read the first intermediate is result vector of the current frame and the LSTM output vector of the previous frame into the processor cache, and enable the processor to access the second submatrix stored in the main memory or the secondary memory, thereby the processor computes the second intermediate result vector for each frame according to the second submatrix of the LSTM parameter matrix, the first intermediate result vector and the LSTM output vector of the previous frame.

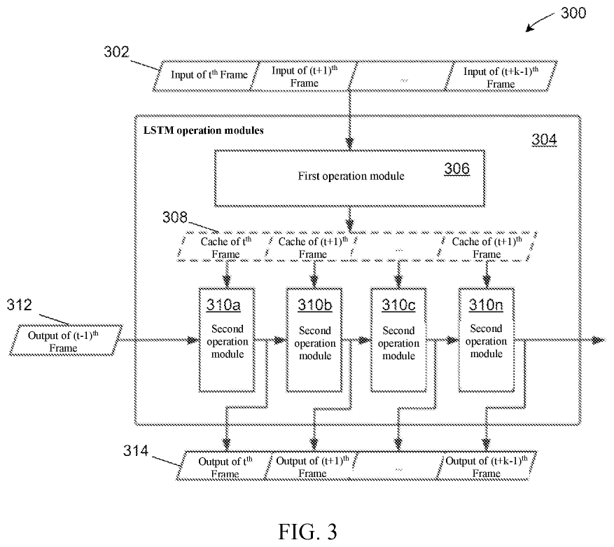

FIG. 3 is a schematic block diagram of a device 300 for executing LSTM neural network operation according to another embodiment of the present disclosure.

According to a non-limiting embodiment of the present disclosure, the LSTM parameters are divided into two parts, i.e., T_{4n,m+n}=[T_{4n,m}¹, T_{4n,n}²], and the LSTM computing is also divided and executed by a first operation module 306 and a second operation module 310 according to different parameters. As a non-limiting example, T_{4n,m}¹, is called a first submatrix and T_{4n,m}² is called a second submatrix. Where, the first operation module 306 receives consecutive inputs of K frames 302 for one time, which is marked as H=[hₜ^{l-1}, hₜ₊₁^{l-1}, . . . , hₜ₊ₖ₋₁^{l-1}]; and an intermediate result cache R=[rₜ¹, rₜ₊₁¹, . . . , rₜ₊ₖ₋₁¹] is obtained by computation via the first operation module 306, and stored in t^{th} frame cache through to (t+k−1)^{th} frame cache, respectively. Referring to FIG. 3, the first operation module according to the embodiment of the present disclosure processes the consecutive inputs of K frames in bulk process instead of frame-by-frame computation.

The second operation module 310 performs frame-by-frame computation. Therefore, the intermediate result vector rₜ¹ of the current frame and the LSTM to output vector hₜ₋₁^{l} of the previous frame need to be input every time for computing an LSTM output vector hₜ^{l} of the current frame, and an LSTM state vector cₜ^{l} is updated accordingly. The LSTM computation of K frames is completed after K cycles of the above-described operation.

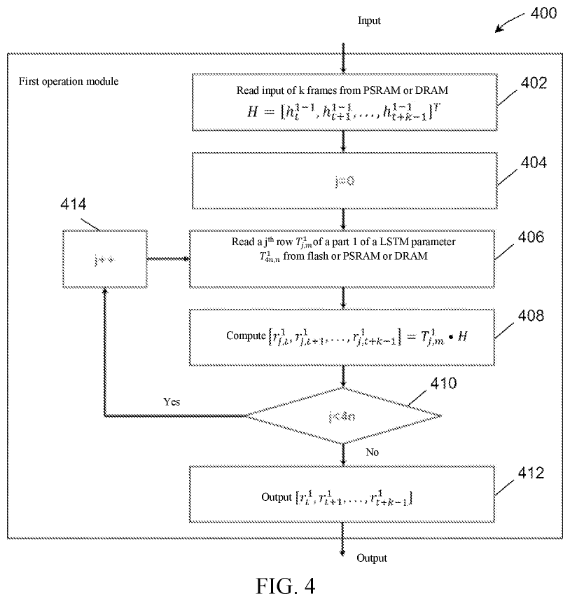

FIG. 4 is a schematic flowchart of computing process performed by the first is operation module of the device for executing LSTM neural network operation according to an embodiment of the present disclosure.

The first operation module performs computation using the following formula:

T_{4n,m}¹·H=R

The specific computing process is shown in FIG. 4. A LSTM parameter T_{4n,m}¹ may be stored in readable storage media, such as flash, PSRAM and DRAM. The computing process is shown below. At step 402, the input vectors of K frames are read into the cache. At step 404, an initial value of a row number of the LSTM parameter T_{4n,m}¹ is set. At step 406, one row T_{j,m}¹ of the LSTM parameter T_{4n,m}¹ is read into the cache. At step 408, T_{j,m}¹·H is computed. At step 410, it is judged whether a next row of the LSTM parameter T_{4n,m}¹ is existed. If so, at step 414, a next row is entered, and the operations of steps 406 and 408 are executed repeatedly. The operation stops until the judgment result at step 410 is “No”. That is, all rows of parameter T_{4n,m}¹ have been traversed. Finally, at step 412, the computation result is output. Since one row T_{j,m}¹ is read for each time, the cache size required is smaller than a size of the processor cache, the one row T_{j,m}¹ will not be expelled from the cache at any time of the computing process with inputs of the K frames, thereby achieving the effect of decreasing cache miss rate. In some embodiments, the inputs of K frames are also stored in the processor cache, so that the device and/or the method of the present disclosure directly obtains data required from the processor cache for computing the inputs of K frames, thereby reducing the access to the main memory and/or the secondary memory and significantly improving the computing efficiency of LSTM neural network operation.

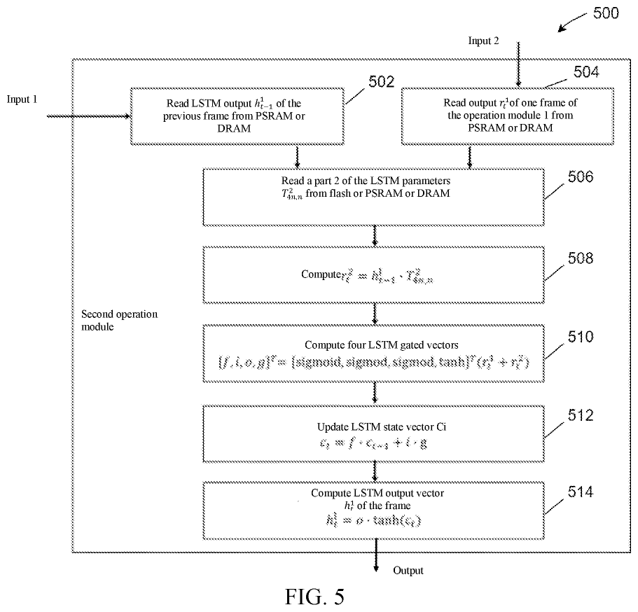

FIG. 5 is a schematic flowchart of a computing process performed by the second operation module of the device for executing LSTM neural network operation according to an embodiment of the present disclosure.

The second operation module performs computation using the following formula:

$$\begin{matrix}{r}_{t}^{2} = {T}_{4 n , n}^{2} \cdot {h}_{t - 1}^{l} \\ [ \begin{matrix}i \\ f \\ o \\ g\end{matrix} ] = [ \begin{matrix}sigmoid \\ sigmoid \\ sigm \\ tanh\end{matrix} ] ( \begin{matrix}{r}_{t}^{1} \\ {r}_{t}^{2}\end{matrix} ) \\ {c}_{t}^{l} = f ⊗ {c}_{t - 1}^{l} + i ⊗ g \\ {h}_{t}^{l} = 0 ⊗ tanh ( {c}_{t}^{l} )\end{matrix}$$

The specific computing process is shown in FIG. 5. At step 504, the intermediate result rₜ¹ of one frame output by the first operation module (i.e., input 2 of the second operation module) is read. At step 502, the LSTM output result hₜ₋₁^{l} of the previous frame (i.e., input 1 of the second operation module) is read. At step 506, the LSTM parameter T_{4n,m}² stored in the readable storage medium, such as flash or PSRAM or DRAM, is read. At step 508, rₜ²=T_{4n,n}²hₜ₋₁^{l} is computed. The computing process is carried out frame by frame due to the dependency on the LSTM output hₜ₋₁^{l} of the previous frame. That is, the computation should not proceed unless the LSTM computation of a previous frame is completed. At step 510, according to rₜ¹ and rₜ², four LSTM gated state vectors [i, f, o, g]^{T} are computed by using the formula above. At step 512, the LSTM state vector cₜ is updated. At step 514, the final LSTM output hₜ^{l} of the frame is obtained.

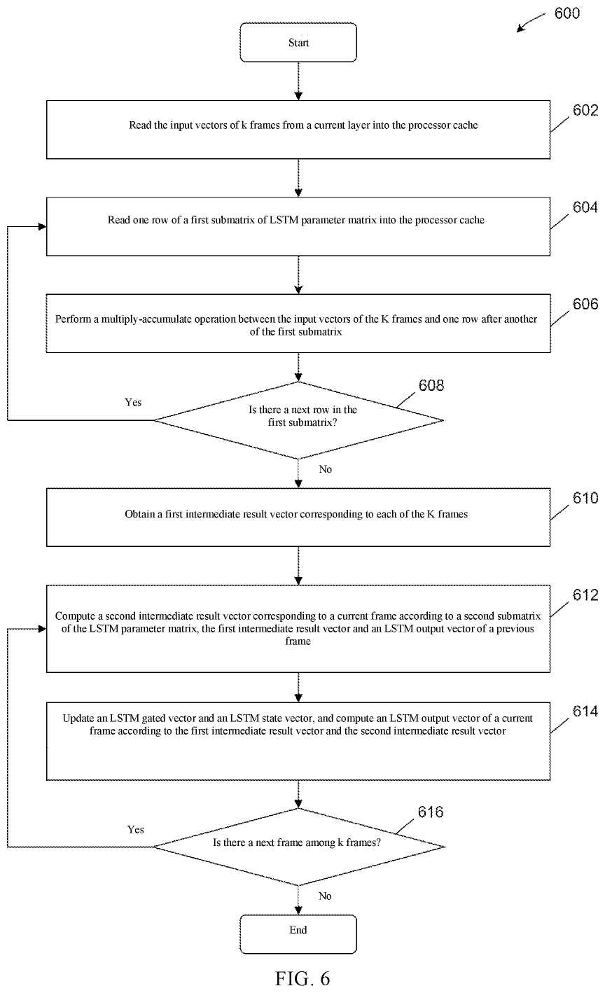

FIG. 6 is a schematic flowchart of a method 600 for executing LSTM neural network operation according to an embodiment of the present disclosure. The method 600 may be performed by using an electronic device, which may include a processor, a processor cache, a main memory and a secondary memory, wherein an access speed of the processor cache is higher than that of the main memory, and an access speed of the main memory is higher than that of the secondary memory.

At step 602, input vectors of K frames from a current layer are read into the processor cache. At step 604, one row from a first submatrix of a LSTM parameter matrix is read into the processor cache. At step 606, a multiply-accumulate operation is performed between the input vectors of the K frames and one row after another of the first submatrix. At step 608, it is judged whether a next row of the first submatrix is existed. If so, return to the step 604 to process the next row of the first submatrix. Otherwise, it is concluded that all rows of the first submatrix have been traversed; and at step 610, a first intermediate result vector corresponding to each of the K frames is obtained. In some embodiments, K is selected such that sizes of the input vectors of the K frames and of one row of the first submatrix of the LSTM parameter matrix are smaller than a size of the processor cache.

Subsequently, steps 612 to 616 are performed on each of the K frames.

At step 612, a second intermediate result vector corresponding to each frame is computed according to a second submatrix of the LSTM parameter matrix, the first intermediate result vector and an LSTM output vector of a previous frame.

At step 614, an LSTM gated vector and an LSTM state vector are updated, and an LSTM output vector of a current frame is computed according to the first intermediate result vector and the second intermediate result vector.

At step 616, it is judged whether the process for the K frames is not completed. If so, return to step 612 to process the next frame; otherwise, the process ends.

According to an embodiment of the present disclosure, the first intermediate result vector of the current frame and the LSTM output vector of the previous frame are read into the processor cache, and the processor is enabled to access the second submatrix in the main memory or the secondary memory, thereby the processor computes the second intermediate result vector for each frame according to the second submatrix of the LSTM parameter matrix, the first intermediate result vector, and the LSTM output vector of the previous frame.

In an embodiment, one row of the first submatrix of the LSTM parameter matrix of the current layer is read from the main memory into the processor cache. As an alternative embodiment, one row of the first submatrix of the LSTM parameter matrix of the current layer is read from the secondary main memory into the processor cache.

According to an embodiment of the present disclosure, the LSTM parameter matrix includes the first submatrix and the second submatrix. It should be understood that the solution of the present disclosure is applicable to partial and/or whole operation of the LSTM parameter matrix, and also applicable to partial and/or whole process of LSTM neural network operation.

According to the device and the method disclosed by the present disclosure, the first operation module performs a parallel computation by taking K (K>=1) frames as a basic unit, thereby greatly improving the cache utilization. Accordingly, the cache utilization of the LSTM parameter during the computation of the first operation module is increased from one time to K times. Since the computing amount of the first part accounts for about 50% of whole operation of the LSTM parameter matrix, it can be worked out that the cache miss rate of the whole operation of the LSTM parameter matrix decreases from 100% to (K−1)/2K. When K is a relatively large value, the cache miss rate is close to 50%, i.e., the cache miss rate is halved.

In an embodiment, the first submatrix of the LSTM parameter matrix of is the current layer is stored in the main memory.

In an embodiment, the first submatrix of the LSTM parameter matrix of the current layer is not stored in the main memory but in the secondary memory with a relatively lower access speed. Contrary to the conventional implementation in the existing techniques that the LSTM parameter matrix is stored in a fast-access memory (e.g., RAM) if possible, according to the alternative embodiment, the first submatrix of the LSTM parameter matrix is not copied into the main memory (e.g., RAM), but is obtained by directly access to the flash during the operation process. The reason is that, depending on the solution of the present disclosure, the cache utilization is capable of being increased to K times for computation of the first submatrix, thereby the actual average time for reading parameters per frame from the flash is about 1/K. When K is a relatively large value, the time for reading parameters from the flash may be ignored to reduce the RAM required for T_{n,4n}¹, size.

It will be appreciated that the specific operation process and steps given in the exemplary embodiments described above should not be construed as limiting the scope of the present disclosure.

Herein, the processor may be implemented by using at least one of a digital signal processor (DSP), a field programmable gate array (FPGA), a programmable logic array (PLA), and an application specific integrated circuit (ASIC), the processor may be a combination of one or more of a central processing unit (CPU) or other forms of processing unit with data processing capability and/or instruction execution capability, can control other components in the electronic device to perform desired functions.

The storage device may include one or more computer program products, said computer program products may include various forms of computer-readable storage medium, such as a volatile memory and/or a nonvolatile memory. The volatile memory may include, for example, a Random Access is Memory (RAM) and/or a cache or the like. The nonvolatile memory may include, for example, a read only memory (ROM), a hard disk, a flash memory or the like. One or more computer program instructions may be stored on the computer-readable storage medium, and the processor may execute the program instructions to implement client functions (implemented by the processor) in embodiments of the present disclosure described below and/or other desired functions. Various application programs and various data may also be stored in the computer-readable storage medium, such as various data used and/or generated by the application programs.

In practical applications, the operation module may be implemented by hardware such as an FPGA or an ASIC, respective functional operation modules may be composed by various logic circuits such as an adder and a multiplier to implement corresponding functional operations. The operation module may include a non-transitory or transitory computer-readable storage medium storing program codes, and the program codes include instructions for executing the method described in the above method embodiments. The above functions may also be stored in one computer-readable storage medium when being implemented in the form of a software functional module and sold and used as an independent product. Based on such understanding, the substance or the part that contributes to the technical solutions of the present disclosure or the technical solution part may be reflected in the form of a software product, the computer software product may be stored in one storage medium, and include several instructions for causing a computer device (which may be a personal computer, a server, or a network device) to fully or partially perform the method described in the various embodiments of the present disclosure. The aforesaid storage medium includes various mediums capable of storing program codes like a mobile storage device, a Read Only Memory (ROM), a magnetic disk, or an optical disk.

Although various embodiments in different aspects of the present is disclosure have been described for the purpose of the present disclosure, it should be understood that the teaching of the present disclosure are not limited thereto. The features disclosed in an embodiment are not limited thereto but may be combined with features disclosed in other embodiments. It should be further understood that the above-described method steps can be executed sequentially or in parallel, combined into fewer steps, divided into additional steps, or combined in a different way than that described herein and/or eliminated. It should be understood by those skilled in the art that the present disclosure includes other alternative embodiments and variations, and various changes and modifications can be made to the above-described components and structures without departing from the scope of the claims of the present disclosure.

1. A device for executing LSTM neural network operation, the device comprising:
a processor, a processor cache, a main memory, a secondary memory, a first operation module and a second operation module, wherein an access speed of the processor cache is higher than that of the main memory, and an access speed of the main memory is higher than that of the secondary memory; wherein
the first operation module is operable to read input vectors of K frames from a current layer into the processor cache and read one row after another from a first submatrix of a LSTM parameter matrix into the processor cache, to enable the processor to perform an multiply-accumulate operation between the input vectors of the K frames and one row after another of the first submatrix, until traversing all rows of the first submatrix to obtain a first intermediate result vector corresponding to each of the K frames, wherein K is greater than 1 and K is selected such that sizes of the input vectors of the K frames and of one row of the first submatrix of the LSTM parameter matrix are smaller than a size of the processor cache;
for each of the K frames, the second operation module is operable to:
cause the processor to compute a second intermediate result vector corresponding to each frame according to a second submatrix of the LSTM parameter matrix, the first intermediate result vector and an LSTM output vector of a previous frame; and
update an LSTM gated vector and an LSTM state vector, and compute an LSTM output vector of a current frame according to the first intermediate result vector and the second intermediate result vector.

2. The device according to claim 1, wherein the second operation module is operable to read the first intermediate result vector of the current frame and the LSTM output vector of the previous frame into the processor cache, and enable the processor to access the second submatrix in one of the main memory and the secondary memory, thereby the processor computes the second intermediate result vector for each frame according to the second submatrix of the LSTM parameter matrix, the first intermediate result vector and the LSTM output vector of the previous frame.

3. The device according to claim 1, wherein the first submatrix of the LSTM parameter matrix of the current layer is stored in the main memory.

4. The device according to claim 1, wherein the first submatrix of the LSTM parameter matrix of the current layer is stored in the secondary memory.

5. The device according to claim 1, wherein the LSTM parameter matrix comprises the first submatrix and the second submatrix.

6. A method for executing LSTM neural network operation by using an electronic device, wherein the electronic device comprises a processor, a processor cache, a main memory and a secondary memory, wherein an access speed of the processor cache is higher than that of the main memory, and an access speed of the main memory is higher than that of the secondary memory; and the method comprises:
reading input vectors of K frames from a current layer into the processor cache and reading one row after another from a first submatrix of a LSTM parameter matrix into the processor cache, and performing an multiply-accumulate operation between the input vectors of the K frames and one row after another of the first submatrix, until traversing all rows of the first submatrix to obtain a first intermediate result vector corresponding to each of the K frames, wherein K is greater than 1 and K is selected such that sizes of the input vectors of the K frames and of one row of the first submatrix of the LSTM parameter matrix are smaller than a size of the processor cache;
for each of the K frames, performing following steps:
computing a second intermediate result vector corresponding to each frame according to a second submatrix of the LSTM parameter matrix, the first intermediate result vector and an LSTM output vector of a previous frame; and
updating an LSTM gated vector and an LSTM state vector, and computing an LSTM output vector of a current frame according to the first intermediate result vector and the second intermediate result vector.

7. The method according to claim 6, further comprises:
reading the first intermediate result vector of the current frame and the LSTM output vector of the previous frame into the processor cache, and
causing the processor to access the second submatrix in one of the main memory and the secondary memory, thereby the processor computes the second intermediate result vector for each frame according to the second submatrix of the LSTM parameter matrix, the first intermediate result vector and the LSTM output vector of the previous frame.

8. The method according to claim 6, wherein one row of the first submatrix of the LSTM parameter matrix of the current layer is read from the main memory into the processor cache.

9. The method according to claim 6, wherein one row of the first submatrix of the LSTM parameter matrix of the current layer is read from the secondary main memory into the processor cache.

10. The method according to claim 6, wherein the LSTM parameter matrix comprises the first submatrix and the second submatrix.
